(19) United States
(12) Patent Application Publication
(10) Pub. No.: US 2025/0247378 A1
(43) Pub. Date: Jul. 31, 2025

(54) METHOD AND APPARATUS FOR PROVIDING INTERNET PROTOCOL SECURITY COMMUNICATION

(71) Applicant: Telefonaktiebolaget LM Ericsson (publ), Stockholm (SE)

(72) Inventors: Daiying LIU, Beijing (CN); Congjie ZHANG, Beijing (CN); Chao ZHOU, Beijing (CN)

(21) Appl. No.: 18/848,379

(22) PCT Filed: Apr. 29, 2022
(86) PCT No.: PCT/CN2022/090332

§ 371 Date: Sep. 18, 2024

(51) Int. Cl. H04L 9/40

(52) U.S. Cl. CPC H04L 63/0485

(57) ABSTRACT

A method by a first device for providing Internet Protocol Security (IPsec) communication with a second device in a network. In response to a request for updating a first old Security Association (SA) from the second device, the method generates a first new SA, and sends, to the second device, an acknowledgement that the first new SA is available at the first device. The method uses the first old SA to encapsulate traffic data sent to the second device until receiving, from the second device, traffic data encapsulated with a second new SA generated at the second device. The method retains the first old SA to have a capability of handling traffic data encapsulated with a second old SA received from the second device until a preset condition is satisfied.

### TECHNICAL FIELD

The present disclosure generally relates to Internet Protocol Security (IPsec) communication, and more specifically, the embodiments herein relate to a method for reducing or eliminating IPsec traffic loss during a rekeying process, an apparatus and computer program product adapted for the same purpose.

### BACKGROUND

IPsec mechanism provides confidentiality, data integrity, access control, and data source authentication to IP datagrams. These services are provided by maintaining a shared state between the source and the sink of an IP datagram. The shared state defines, among other things, the specific services provided to the datagram, the cryptographic algorithms applied to the services, and the keys used as input to the cryptographic algorithms.

Internet Key Exchange (IKE) performs mutual authentication between two parties and then establishes an IKE Security Association (SA) including shared secret information for Encapsulating Security Payload (ESP) or Authentication Header (AH) and a set of cryptographic algorithms to be used by the SAs to protect the traffic that they carry.

SAs use secret keys that should be used only for a limited amount of time or a limited amount of data. This limits the lifetime of an SA. When the lifetime expires, it shall be banned; afterwards new SAs may be established if necessary. Hereinafter, reestablishment of new SAs to replace old SAs or ones that expire is referred to as “rekeying”.

The detailed description on the IPsec communication may be found in “RFC7296: Internet Key Exchange Protocol Version 2 (IKEv2)”, which is incorporated herein by reference in its entirety.

### SUMMARY

The present disclosure proposes a solution where a temporary coexistence mechanism for old and new SAs is introduced to solve the traffic loss problem during rekeying in IPsec communication.

In one or more embodiments according to the present disclosure, there proposes a method for providing Internet Protocol Security (IPsec) communication between a first device and a second device in a network. In the method, in response to a request for updating a first old Security Association (SA) from the second device, the first device may generate a first new SA. Then, the first device may send, to the second device, an acknowledgement that the first new SA is available at the first device. Moreover, the first device may use the first old SA to encapsulate traffic data sent to the second device until receiving, from the second device, traffic data encapsulated with a second new SA generated at the second device, retains the first old SA to have a capability of handling traffic data encapsulated with a second old SA received from the second device until a preset condition is satisfied. In the method, the first new SA is identical or corresponds to the second new SA, and the first old SA is identical or corresponds to the second old SA.

In some embodiments, after receiving the traffic data encapsulated with the second new SA from the second device for the first time, the first device may start to use the first new SA to encapsulate the traffic data sent to the second device.

In some embodiments, the first and second device is one selected from a group consisting of router, Layer 3 switch and firewall.

In some embodiments, the request for updating the first old SA is implemented as a create child SA request message.

In some embodiments, the acknowledgement is implemented by sending to the second device a create child SA response message.

In some embodiments, the preset condition comprises one or more of the following events:
A) an amount of data packets encapsulated with the second new SA received from the second device exceeds a first threshold;
B) the time elapsed after receiving a data packet encapsulated with the second new SA from the second device for the first time exceeds a second threshold; and
C) a data packet indicated as last one encapsulated with the second old SA at the second device is received.

In some embodiments, the first or second threshold is determined on the basis of at least one of a throughput capability of the first or second device, a traffic transmission rate and an estimated communication link delay.

In one or more embodiments according to the present disclosure, there proposes a first device for providing Internet Protocol Security (IPsec) communication with a second device in a network. The first device may comprise a storage device configured to store a computer program comprising computer instructions; and at least one processor coupled to the storage device and configured to execute the computer instructions to carry out the steps of the above method.

In one or more embodiments according to the present disclosure, there proposes a method for providing Internet Protocol Security (IPsec) communication between a first device and a second device in a network. In the method, the second device may send, to the first device, a request for updating a first old Security Association (SA). Then, the second device may receive, from the first device, an acknowledgement that a new first SA generated at the first device is available and generate a second new SA to encapsulate traffic data sent to the first device. Moreover, the second device may retain a second old SA to have a capability of handling traffic data encapsulated with the first old SA received from the first device until a preset condition is satisfied. In the method, the first new SA is identical or corresponds to the second new SA, and the first old SA is identical or corresponds to the second old SA.

In some embodiments, the preset condition comprises one or more of the following events:
A) an amount of data packets encapsulated with the first new SA received from the first device exceeds a first threshold;
B) the time elapsed after receiving a first data packet encapsulated with the first new SA from the first device exceeds a second threshold; and
C) a data packet indicated as last one encapsulated with the first old SA at the first device is received.

In one or more embodiments according to the present disclosure, there proposes a second device for providing Internet Protocol Security (IPsec) communication with a first device in a network. The second device may comprisee a storage device configured to store a computer program comprising computer instructions; and at least one processor coupled to the storage device and configured to execute the computer instructions to carry out the steps of the method according to the above method.

In one or more embodiments according to the present disclosure, there proposes a computer program product being embodied in a computer readable storage medium and comprising computer instructions for carrying out the steps of the above methods.

In some embodiments according to the present disclosure, the first device would continue to use its old SA until the rekeying is completed at the second device, and thus the event of traffic broken can be avoided without affecting the communication efficiency between the two devices. Moreover, in some embodiments according to the present disclosure, after the rekeying is completed, the first and second devices would retain their respective old SAs until a preset condition is satisfied. Therefore, the two devices still have a capability of handling the traffic data encapsulated with the peers' old SAs and the traffic loss can be avoided or reduced without affecting the communication efficiency between the two devices. Furthermore, in some embodiments of the present disclosure, the preset condition may be set flexibly to adapt to various application scenarios.

### BRIEF DESCRIPTION ON DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic signaling flow chart illustrating a typical rekeying process 100.

FIG. 2 is a schematic flow chart illustrating an exemplary method 200 according to one or more embodiments of the present disclosure.

FIG. 3 is a schematic flow chart showing an exemplary method 300 according to one or more embodiments of the present disclosure.

FIG. 4 is a schematic flow chart illustrating an exemplary method 400 according to one or more embodiments of the present disclosure.

FIG. 5 is a schematic flow chart showing an exemplary method 500 according to one or more embodiments of the present disclosure.

FIG. 6 is a schematic signaling flow chart illustrating a rekeying process 600 according to one or more embodiments of the present disclosure.

FIG. 7 is a block diagram illustrating a device for providing Internet Protocol Security (IPsec) communication according to one or more embodiments of the present disclosure.

FIG. 8 is a block diagram illustrating a first network function for providing Internet Protocol Security (IPsec) communication according to one or more embodiments of the present disclosure.

FIG. 9 is a block diagram illustrating a second network function for providing Internet Protocol Security (IPsec) communication according to one or more embodiments of the present disclosure.

### DETAILED DESCRIPTION ON EMBODIMENTS

In the following detailed description, numerous specific details such as logic implementations, types and interrelationships of system components, etc. are set forth in order to provide a more thorough understanding of the present disclosure. It should be appreciated, however, by those skilled artisans in the art that the present disclosure may be practiced without such specific details. In other instances, control structures, circuits and instruction sequences have not been shown in detail in order not to obscure the present disclosure. Those skilled artisans in the art, with the included descriptions, will be able to implement appropriate functionality without undue experimentation.

References in the disclosure to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of those skilled artisans in the art to affect such feature, structure, or characteristic in connection with other embodiments whether or not explicitly described.

In the following detailed description and claims, the phrase “A, B, or C” used herein means “A” or “B” or “C”; the phrase “A, B, and C” used herein means “A” and “B” and “C”; the phrase “A, B, and/or C” used herein means “A”, “B”, “C”, “A and B”, “A and C”, “B and C” or “A, B, and C”.

In the following detailed description and claims, the terms “coupled” and “connected”, along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

The embodiments herein can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In the present disclosure, these implementations, or any other form that the embodiments may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

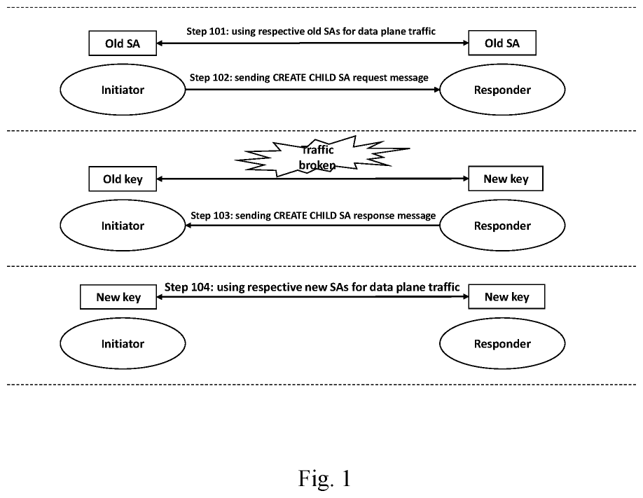

FIG. 1 is a schematic signaling flow chart illustrating a typical rekeying process 100. The rekeying process 100 includes the following steps:
Step 101: A secure encrypted communication under IPsec protocol is provided between a pair of two devices or computers over an Internet Protocol (IP) network. The examples of the devices include but are not limited to router, Layer 3 switch and firewall and the like.
Step 102: One of the devices, i.e., denoted as Initiator, initiates a rekeying process by sending, to another one, i.e., denoted as Responder, a CREATE_CHILD_SA request message for updating an old SA at the Responder.
Step 103: In response to the CREATE_CHILD_SA request message, the Responder creates or generates a new SA, deletes the old SA, and notifies the Initiator that the new SA is in use at the Responder by sending a CREATE_CHILD_SA response message.
Step 104: The Initiator updates its own SA and begins to use a new SA generated locally. As a result, the rekeying process has been completed and the traffic between the Initiator and the Responder is carried out with the new SAs.

However, during an time interval from the using of the new SA at the Responder to the receipt of the response (hereinafter also referred to as “traffic broken period”), since the rekeying of the SA has not been completed at the Initiator, those inbound packets encapsulated with the new SA at the Responder can not be properly handled by the Initiator, i.e., the traffic loss occurs. This period depends on a variety of factors, e.g., a distance between the Initiator and the Responder, network bandwidth available for IPsec communication, network quality or transmission delay, and processing capability or computing resources at the Initiator and the Responder. In some scenario, the period may be hundreds of million seconds, even seconds. For 5 Gbps of IPsec throughput, this means that several Gigabits of the traffic data may be dropped during the IPsec rekeying process in the worst case.

Furthermore, even after the rekeying is completed at both sides, it cannot ensure inbound packets can always be handled. For example, for those packets encapsulated with the old SA but received from one of the Initiator and the Responder after the rekeying, the peer device cannot handle them as the old SA has been deleted therein, and thus traffic loss occurs.

In some critical 5G scenarios, e.g., remote medical operation, where a full data encrypted and zero packet loss are required, it is particularly desirable to avoid the traffic loss.

Although it may avoid the traffic loss during the IPsec rekeying by temporarily suspending IPsec traffic between two IPsec tunnel end points until the completion of the rekeying, this synchronization approach is unfeasible due to low efficiency.

In one or more embodiments of the present disclosure, after the Responder creates its new SA, it would continue to use its old SA to encapsulate the traffic data sent to the Initiator until the rekeying is completed at the Initiator. For example, the Responder may consider the receipt of traffic data encapsulated with the Initiator's new SA as an indicator on the completion of the rekeying. At the Responder side, since the transition from the old SA to the new SA does not occur immediately after the new SA is created, the traffic broken period can be avoided.

In one or more embodiments of the present disclosure, the Responder would retain its old SA even if it determines the rekeying is completed at the Initiator. That is, the old SA would not be deleted until a preset condition is satisfied. As a result, the Responder still has a capability of handling the traffic data encapsulated with the Initiator's old SA after the rekeying at the Initiator has been completed. Similarly, after completing the rekeying, the Initiator would retain its old SA until a preset condition is satisfied so as to have a capability of handling the traffic data encapsulated with the Responder's old SA.

In one or more embodiments of the present disclosure, the deletion of the old SAs may be triggered by one or more of the following events:

A) an amount of data packets encapsulated with the Initiator's new SA or the Responder's new SA exceeds a first threshold;
B) the time elapsed after receiving a data packet encapsulated with the Initiator's new SA or the Responder's new SA for the first time exceeds a second threshold; and
C) a data packet indicated as last one encapsulated with the Initiator's old SA or the Responder's old SA is received.

Optionally, the first or second threshold as mentioned above is determined on the basis of a variety of factors, e.g., including but not limited to a throughput capability of the Initiator or the Responder, a traffic transmission rate and an estimated communication link delay and the like. For example, the higher the transmission rate or the longer the delay, the greater the second threshold.

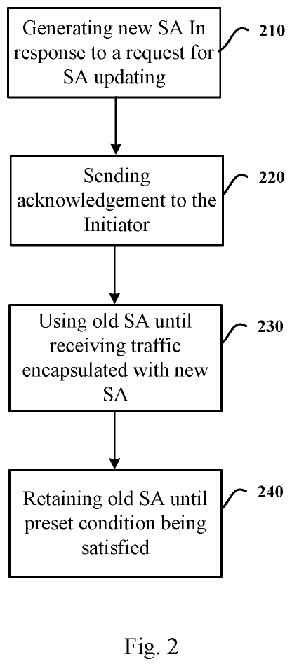

FIG. 2 is a schematic flow chart illustrating an exemplary method 200 according to one or more embodiments of the present disclosure. For illustrative purpose, the following description is made in the context of IPsec communication between a first device (e.g., the Responder as shown in FIG. 1) and a second device (e.g., the Initiator as shown in FIG. 1) in an IP network. The examples of the first and second device include but are not limited to router, Layer 3 switch and firewall. Unless otherwise specified, the first device and the Responder are used interchangeably in the following description, so are the second device and the Initiator.

With reference to FIG. 2, the method 200 comprises the following steps carried out at the first device:
Step 210: When the first device or the Responder receives from the second device a request for updating a first old SA or the Responder's old SA, it would generate a first new SA or the Responder's new SA. Optionally, the request for updating the first old SA may be implemented as a CREATE CHILD SA request message. In the present embodiments, the Responder's old SA would not be deleted immediately after its new SA is created.
Step 220: The Responder sends an acknowledgement to the Initiator which would create its new SA and send data packets encapsulated with its new SA. The acknowledgement indicates that the Responder's new SA is available for encrypting the traffic data at the Responder, i.e., the new SA can be used but is not in use at this time. Optionally, the acknowledgement may be implemented as a CREATE CHILD SA response message.
Step 230: If no data packet encapsulated with the Initiator's new SA has been received from the Initiator, the Responder would encapsulate traffic data sent to the Initiator with the Responder's old SA; otherwise, the Responder would begin to encapsulate the traffic data sent to the Initiator with the Responder's new SA.
Step 240: After receiving the data packet encapsulated with the Initiator's new SA, the Responder would not delete its old SA immediately. In contrast, the Responder would retain its old SA so that the traffic data encapsulated with the Initiator's old SA can be handled until a preset condition is satisfied.

In some illustrative examples, the preset condition may include at least one of the following:
an amount of data packets encapsulated with the Initiator's new SA exceeds a first threshold;
the time elapsed after receiving a data packet encapsulated with the Initiator's new SA for the first time exceeds a second threshold;
a data packet indicated as last one encapsulated with the Initiator's old SA is received.

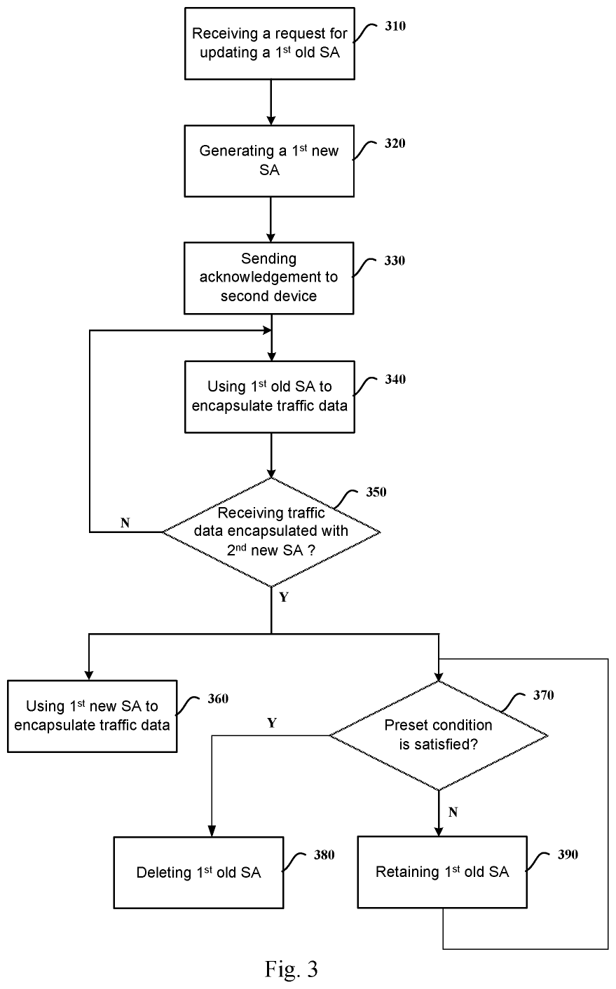

FIG. 3 is a schematic flow chart showing an exemplary method 300 according to one or more embodiments of the present disclosure. For illustrative purpose, the following description is made in the context of IPsec communication between a first device (e.g., the Responder as shown in FIG. 1) and a second device (e.g., the Initiator as shown in FIG. 1) in an IP network. The examples of the first and second device include but are not limited to router, Layer 3 switch and firewall. Unless otherwise specified, the first device and the Responder are used interchangeably in the following description, so are the second device and the Initiator.

The method 300 begins with step 310 where the first device or the Responder receives from the second device or the Initiator a request for updating a first old SA or the Responder's old SA. As an example, the request may be implemented as a CREATE CHILD SA request message.

Then the method 300 proceeds to step 320 where the Responder creates its new SA or the first new SA. Also, the Responder's old SA would not be deleted immediately after its new SA is created.

The method 300 further proceeds to step 330 where the Responder sends to the Initiator an acknowledgement indicating that the Responder's new SA is available for encrypting the traffic data, i.e., the new SA can be used but is not in use at this time. For example, the acknowledgement may be implemented as a CREATE CHILD SA response message.

The method 300 further proceeds to step 340 where the Responder would encapsulate traffic data sent to the Initiator with the Responder's old SA.

The method 300 then proceeds to step 350 where the Responder determines whether any data packets encapsulated with the Initiator's new SA have been received from the Initiator. If it is the case, the method 300 proceeds to steps 360 and step 370 carried out in parallel; otherwise, the method 300 proceeds to step 340

At step 360, the Responder would begin to encapsulate the traffic data sent to the Initiator with the Responder's new SA.

At step 370, the Responder would determines whether a preset condition is satisfied. If it is the case, the method proceeds to step 380 where the Responder deletes its old SA; otherwise, the method proceeds to step 390 where the Responder retains its old SA. The content of the preset condition has been described above and will not be repeated herein.

After step 390, the method 300 proceeds to step 370.

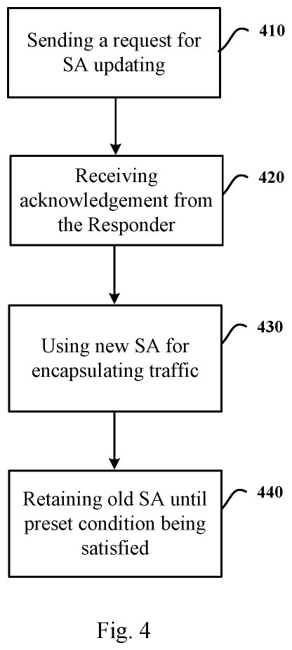

FIG. 4 is a schematic flow chart illustrating an exemplary method 400 according to one or more embodiments of the present disclosure. For illustrative purpose, the following description is made in the context of IPsec communication between a first device (e.g., the Responder as shown in FIG. 1) and a second device (e.g., the Initiator as shown in FIG. 1) in an IP network. The examples of the first and second device include but are not limited to router, Layer 3 switch and firewall. Unless otherwise specified, the first device and the Responder are used interchangeably in the following description, so are the second device and the Initiator.

With reference to FIG. 4, the method 400 comprises the following steps carried out at the second device:
Step 410: The second device or the Initiator sends to the first device or the Responder a request for updating a first old SA or the Responder's old SA. Optionally, the request for updating the first old SA may be implemented as a CREATE CHILD SA request message.
Step 420: The Initiator receives from the Responder an acknowledgement indicating that the Responder's new SA is available for encrypting the traffic data, i.e., the new SA can be used but is not in use at this time. Optionally, the acknowledgement may be implemented as a CREATE CHILD SA response message.
Step 430: The Initiator Responder begins to encapsulate the traffic data sent to the Responder with the Initiator's new SA.
Step 440: After creating its new SA or the Initiator's new SA, the Initiator would not delete its old SA immediately. In contrast, the Initiator would retain its old SA so that the traffic data encapsulated with the Responder's old SA can be handled until a preset condition is satisfied.

Similarly, the preset condition may include at least one of the following:
an amount of data packets encapsulated with the Responder's new SA exceeds a first threshold;
the time elapsed after receiving a data packet encapsulated with the Responder's new SA for the first time exceeds a second threshold;
a data packet indicated as last one encapsulated with the Responder's old SA is received.

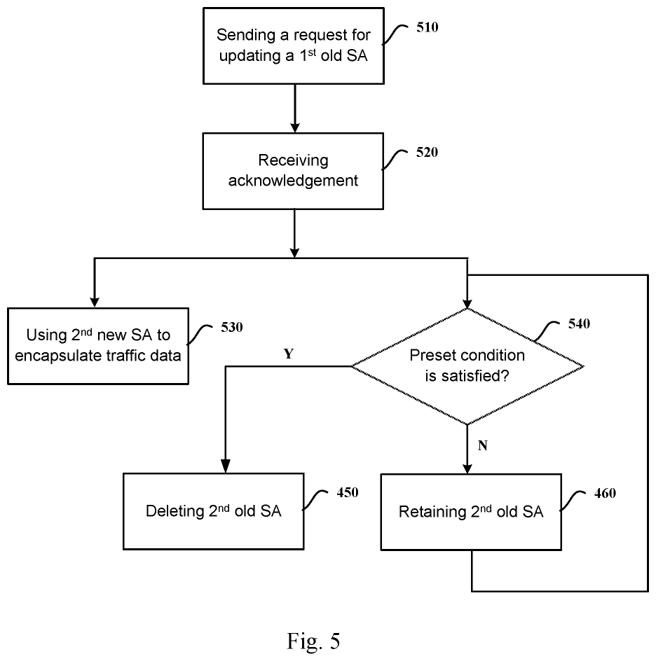

FIG. 5 is a schematic flow chart showing an exemplary method 500 according to one or more embodiments of the present disclosure. For illustrative purpose, the following description is made in the context of IPsec communication between a first device (e.g., the Responder as shown in FIG. 1) and a second device (e.g., the Initiator as shown in FIG. 1) in an IP network. The examples of the first and second device include but are not limited to router, Layer 3 switch and firewall. Unless otherwise specified, the first device and the Responder are used interchangeably in the following description, so are the second device and the Initiator.

The method 500 begins with step 510 where the second device or the Initiator sends to the first device or the Responder a request for updating a first old SA or the Responder's old SA, e.g., in form of a CREATE CHILD SA request message.

Then the method 500 proceeds to step 520 where the Initiator receives from the Responder an acknowledgement indicating that the Responder's new SA is available for encrypting the traffic data at the Responder, i.e., the new SA can be used but is not in use at this time. For example, the acknowledgement may be implemented as a CREATE CHILD SA response message.

The method 500 further proceeds to step 530 and 540 carried out in parallel.

At step 530, the Initiator would create its new SA and begin to use its new SA to encapsulate traffic data sent to the Responder.

At step 540, the Initiator determines whether a preset condition is satisfied. If it is the case, the method proceeds to step 550 where the Initiator deletes its old SA; otherwise, the method proceeds to step 560 where the Initiator retains its old SA. The content of the preset condition has been described above and will not be repeated herein.

After step 560, the method 500 proceeds to step 540.

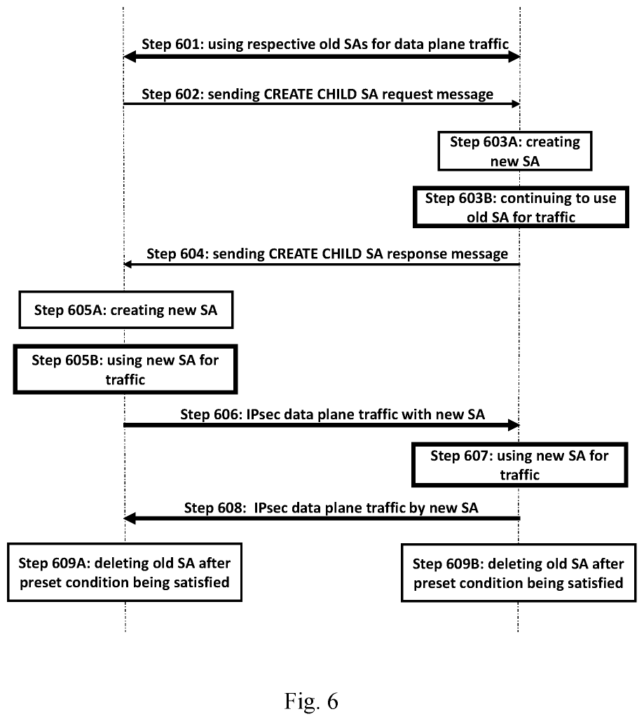

FIG. 6 is a schematic signaling flow chart illustrating a rekeying process 600 according to one or more embodiments of the present disclosure.

The rekeying process 600 includes the following steps:
Step 601: The Initiator and the Responder use their respective old SAs for data plane traffic. The examples of the Initiator and the Responder include but are not limited to router, Layer 3 switch and firewall and the like.
Step 602: The Initiator initiates a rekeying process by sending to the Responder a CREATE_CHILD_SA request message for updating an old SA at the Responder.
Step 603A: In response to the CREATE_CHILD_SA request message, the Responder creates a new SA.
Step 603B: The Responder continues to use its old SA to encapsulate data packets sent to the Initiator.
Step 604: The Responder sends a CREATE_CHILD_SA response message to notify the Initiator that the new SA is available for encrypting the traffic data at the Responder, i.e., the new SA can be used but is not in use at this time.
Step 605A: In response to the CREATE_CHILD_SA response message, the Initiator creates its new SA.
Step 605B: The Initiator begins to use its new SA to encapsulate data packets sent to the Responder.
Step 606: The Initiator sends the data packets encapsulated with the new SA to the Responder.
Step 607: In response to the receipt of the data packets encapsulated with the Initiator's new SA, the Responder begins to use its new SA to encapsulate data packets sent to the Initiator.
Step 608: The Responder sends the data packets encapsulated with the new SA to the Initiator.
Step 609A: After a preset condition is satisfied, the Initiator would delete its old SA.
Step 609B: After a preset condition is satisfied, the Responder would delete its old SA.

In some embodiments, steps 601, 603B, 605B, 606, 607 and 608 represented with solid thick lines or solid thick blocks can be performed on a user plane, and steps 602, 603A, 604, 605A, 609A and 609B represented with solid thin lines or solid thin blocks can be performed on a control plane. However, it shall be noted that the above implementation is only for an illustrative purpose and these steps may be performed on anyone of the user plane and the control plane. Furthermore, these steps can be implemented either by hardware, software instance running on hardware, or a virtualized function instantiated on an appropriate platform, e.g. on a cloud infrastructure.

In the above embodiments as described with reference to FIGS. 2-6, the first new SA or the Responder's new SA is identical or corresponds to the second new SA or the Initiator's new SA, and the first old SA or the Responder's old SA is identical or corresponds to the second old SA or the Initiator's old SA.

In the above embodiments as described with reference to FIGS. 2-6, the Responder may determines whether the Initiator uses its new SA or old SA from Security Parameter Index (SPI) in Encapsulating Security Payload (ESP) of an IPsec data packet.

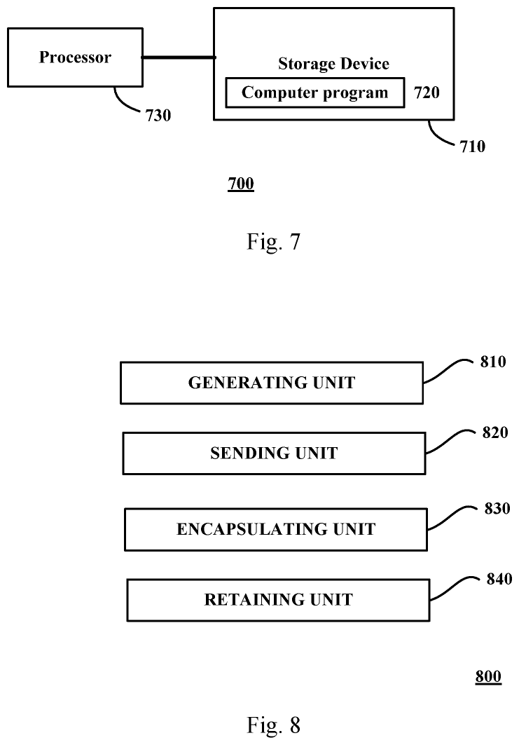

FIG. 7 is a block diagram illustrating a device for providing Internet Protocol Security (IPsec) communication according to one or more embodiments of the present disclosure. The first device, the second device, the Initiator and the Responder and the like as described above may be implemented as the device as shown in FIG. 7.

With reference to FIG. 7, the device 700 may comprise a storage device 710 configured to store a computer program 720 comprising computer instructions executable by the at least one processor 730, whereby the at least one processor 730 is configured to perform the steps in the exemplary methods as shown in FIGS. 2-6.

Note that, the device 700 may be implemented as hardware, software, firmware and any combination thereof. For example, the device 700 may include a plurality of units, circuities, modules or the like, each of which may be used to perform one or more steps of the exemplary methods, or one or more steps shown in FIGS. 2-6.

FIG. 8 is a block diagram illustrating a first network function 800 for providing Internet Protocol Security (IPsec) communication according to one or more embodiments of the present disclosure.

As shown in FIG. 8, the first network function 800 may comprises a generating unit 810, a sending unit 820, a encapsulating unit 830 and a retaining unit 840. The generating unit 810 is configured to, in response to a request for updating a first old Security Association from a peer network function, generate a first new SA. The sending unit 820 is configured to send, the peer network function, an acknowledgement that the first new SA is available at the first network function. The encapsulating unit 830 is configured to use the first old SA to encapsulate traffic data sent to the peer network function until receiving, from the peer network function, traffic data encapsulated with a second new SA generated at the peer network function. The retaining unit 840 is configured to retain the first old SA to have a capability of handling traffic data encapsulated with a second old SA received from the peer network function until a preset condition is satisfied. In the embodiments as shown in FIG. 8, the first new SA is identical or corresponds to the second new SA, and the first old SA is identical or corresponds to the second old SA.

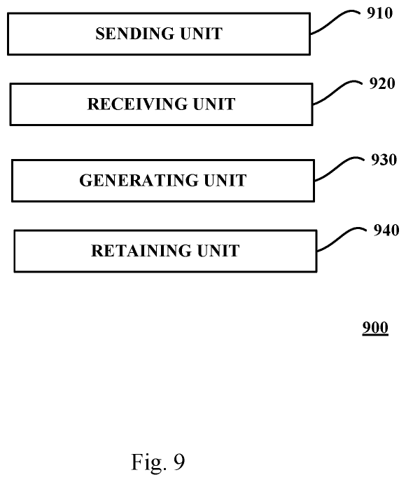

FIG. 9 is a block diagram illustrating a second network function for providing Internet Protocol Security (IPsec) communication according to one or more embodiments of the present disclosure.

As shown in FIG. 9, the second network function 900 may comprises a sending unit 910, a receiving unit 920, a generating unit 930 and a retaining unit 940. The sending unit 910 is configured to send, to a peer network function, a request for updating a first old Security Association (SA). The receiving unit 920 is configured to receive, from the first device, an acknowledgement that a new first SA generated at the peer network function is available, The generating unit 930 is configured to generate a second new SA to encapsulate traffic data sent to the peer network function. The retaining unit 940 is configured to retain a second old SA to have a capability of handling traffic data encapsulated with the first old SA received from the peer network function until a preset condition is satisfied.

The network function or network node as shown in FIGS. 8 and 9 can be implemented either as a network element on a dedicated hardware, as a software instance running on a dedicated hardware, or as a virtualized function instantiated on an appropriate platform, e.g. on a cloud infrastructure.

According to one aspect of the present disclosure, it provides a computer program product being embodied in a computer readable storage medium and comprising computer instructions for performing one or more steps of the exemplary methods, or one or more steps shown in FIGS. 2-6.

An electronic device stores and transmits (internally and/or with other electronic devices) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical interfaces to establish connections (to transmit and/or receive code and/or data using propagating signals) with other electronic devices. One or more parts of an embodiment of the present disclosure may be implemented using different combinations of software, firmware, and/or hardware.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more signal processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed signal processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

1. A method for providing Internet Protocol Security (IPsec) communication between a first device and a second device in a network, comprising the following steps carried out by the first device:
in response to a request for updating a first old Security Association (SA) from the second device, generating a first new SA;
sending, to the second device, an acknowledgement that the first new SA is available at the first device;
using the first old SA to encapsulate traffic data sent to the second device until receiving, from the second device, traffic data encapsulated with a second new SA generated at the second device; and
retaining the first old SA to have a capability of handling traffic data encapsulated with a second old SA received from the second device until a preset condition is satisfied,
wherein the first new SA is identical or corresponds to the second new SA, and the first old SA is identical or corresponds to the second old SA.

2. The method according to claim 1, further comprising:
after receiving the traffic data encapsulated with the second new SA from the second device for the first time, starting to use the first new SA to encapsulate the traffic data sent to the second device.

3. The method according to claim 1, wherein the first and second device is one selected from a group consisting of router, Layer 3 switch and firewall.

4. The method according to claim 1, wherein the request for updating the first old SA is implemented as a create child SA request message.

5. The method according to claim 1, wherein the acknowledgement is implemented by sending to the second device a create child SA response message.

6. The method according to claim 1, wherein the preset condition comprises one or more of the following events:
A) an amount of data packets encapsulated with the second new SA received from the second device exceeds a first threshold;
B) the time elapsed after receiving a data packet encapsulated with the second new SA from the second device for the first time exceeds a second threshold; and
C) a data packet indicated as last one encapsulated with the second old SA at the second device is received.

7. The method according to claim 6, wherein the first or second threshold is determined on the basis of at least one of a throughput capability of the first or second device, a traffic transmission rate and an estimated communication link delay.

8. A first device for providing Internet Protocol Security (IPsec) communication with a second device in a network, comprising:
a storage device configured to store a computer program comprising computer instructions; and
at least one processor coupled to the storage device and configured to execute the computer instructions to carry out the step of the method according to claim 1:
in response to a request for updating a first old Security Association (SA) from the second device, generating a first new SA;
sending, to the second device, an acknowledgement that the first new SA is available at the first device;
using the first old SA to encapsulate traffic data sent to the second device until receiving, from the second device, traffic data encapsulated with a second new SA generated at the second device; and
retaining the first old SA to have a capability of handling traffic data encapsulated with a second old SA received from the second device until a preset condition is satisfied, wherein the first new SA is identical or corresponds to the second new SA, and the first old SA is identical or corresponds to the second old SA.

9. (canceled)

10. A method for providing Internet Protocol Security (IPsec) communication between a first device and a second device in a network, comprising the following steps carried out by the second device:
sending, to the first device, a request for updating a first old Security Association (SA);
receiving, from the first device, an acknowledgement that a new first SA generated at the first device is available;
generating a second new SA to encapsulate traffic data sent to the first device; and
retaining a second old SA to have a capability of handling traffic data encapsulated with the first old SA received from the first device until a preset condition is satisfied,
wherein the first new SA is identical or corresponds to the second new SA, and the first old SA is identical or corresponds to the second old SA.

11. The method according to claim 10, wherein the first and second device is one selected from a group consisting of router, Layer 3 switch and firewall.

12. The method according to claim 10, wherein the request for updating the old SA is implemented as a create child SA request message.

13. The method according to claim 10, wherein the acknowledgement is implemented as a create child SA response message received from the first device.

14. The method according to claim 10, wherein the preset condition comprises one or more of the following events:
A) an amount of data packets encapsulated with the first new SA received from the first device exceeds a first threshold;
B) the time elapsed after receiving a first data packet encapsulated with the first new SA from the first device exceeds a second threshold; and
C) a data packet indicated as last one encapsulated with the first old SA at the first device is received.

15. The method according to claim 14, wherein the first or second threshold is determined on the basis of at least one of a throughput capability of the first or second device, a traffic transmission rate and an estimated communication link delay.

16. A second device for providing Internet Protocol Security (IPsec) communication with a first device in a network, comprising:
a storage device configured to store a computer program comprising computer instructions; and
at least one processor coupled to the storage device and configured to execute the computer instructions to carry out the step of claim 10:
sending, to the first device, a request for updating a first old Security Association (SA);
receiving, from the first device, an acknowledgement that a new first SA generated at the first device is available;
generating a second new SA to encapsulate traffic data sent to the first device; and
retaining a second old SA to have a capability of handling traffic data encapsulated with the first old SA received from the first device until a preset condition is satisfied, wherein the first new SA is identical or corresponds to the second new SA, and the first old SA is identical or corresponds to the second old SA.

17. (canceled)
